(19) United States
(12) Patent Application Publication
(10) Pub. No.: US 2011/0014530 A1
(43) Pub. Date: Jan. 20, 2011

(54) RESERVOIR FOR HOT WEATHER OPERATION OF EVAPORATIVELY COOLED FUEL CELL

(76) Inventors: Ryan J. Balliet, Oakland, CA (US); Robert M. Darling, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/922,956

(22) PCT Filed: Apr. 8, 2008
(86) PCT No.: PCT/US08/59607

§ 371 Date: Sep. 16, 2010

(51) Int. Cl. H01M 8/04

(52) U.S. Cl. 429/414; 429/512

(57) ABSTRACT

A fuel cell system includes a fuel cell having a cathode and an anode. A water flow field is in communication with the cathode for producing moist air. A cooling system for an evaporatively cooled fuel cell includes a condenser arranged to receive the moist air and produce condensed water. A separator may be arranged to receive the condensed water. A return line fluidly connects the separator and the water flow field. A reservoir has additional water that is in fluid communication with the return line for selectively providing the additional water to the water flow field in an out-of-balance hot fuel cell condition. The reservoir is connected in and to the cooling system in a manner that does not block water flow if the reservoir freezes.

### BACKGROUND

This disclosure relates to a fuel cell that utilizes a water reservoir for an out-of-water-balance hot fuel cell condition.

One type of fuel cell utilizes a porous water transport plate that must be sufficiently hydrated for desired fuel cell operation. The fuel cell also must be sufficiently cooled for desired operation. Evaporative cooling of a fuel cell relies upon water in the fuel cell, both produced internally and introduced from externally as coolant, being evaporated into the air stream associated with the fuel cell cathode. That evaporated water is then typically recovered from the moist air stream, as by condensation with a condenser, for return to the fuel cell for reuse.

During hot weather operation of the fuel cell, the condenser becomes less efficient in condensing the water vapor due to the much lower temperature difference between ambient air and the fuel cell exhaust. As a result, gas ingestion and thermal runaway can occur as the water available within the fuel cell for hydrating the porous water transport plate and cooling the fuel cells decreases below a desired amount. In one example, an 85 kW evaporatively cooled fuel cell requires 32 g/s of water to be returned to the fuel cell at full power. If the condenser can only condense 80 percent of this amount on a hot weather day, then after approximately two and a half minutes the fuel cell would be one liter below a desired water amount.

Providing a fuel cell that has sufficient water for hot weather conditions poses a problem because the fuel cell cooling system must be freeze tolerant for cold weather conditions. This requires frozen water within the fuel cell cooling system to be thawed. Thawing such a large volume of water requires an undesirably large amount of power. What is needed is an evaporatively cooled fuel cell that has sufficient water available for hot weather conditions without increasing the volume of water that must be thawed in the fuel cell cooling system.

### SUMMARY OF THE INVENTION

A fuel cell system includes a fuel cell having a cathode, an anode, and an electrolyte there between, as for example a polymer membrane. A water flow field in the fuel cell is in communication with the anode and/or the cathode for humidifying and cooling the fuel cell using recirculated water and water produced from the electrochemical reaction and evaporated into the cathode reactant channel to produce moist air. The water in that moist air is recovered by a condensing cooling system and is returned to the fuel cell. A condensing cooling system includes a condenser arranged to receive the moist air exhaust and produce condensed water. A separator is arranged to separate the condensed water from the exhaust and separate liquid water from air. A return line fluidly connects the condensed water, typically via a separator, to the fuel cell water flow field. A reservoir has additional water that is at least past of the time in fluid communication with the return line for selectively providing the additional water to the water flow field in an out-of-balance hot fuel cell condition. The reservoir is in parallel fluid relation with the condenser in the coolant system, so that the water in the reservoir does not need to be thawed when the system is frozen.

The coolant water for the fuel cell is provided by a cooling loop that receives the moist air from the cathode air flow field to produce liquid water. The liquid water is returned to the water flow field associated with the cathode and/or anode. Additional water is selectively supplied to the water flow field under predetermined operating conditions. During cold weather conditions, the water in the condenser, separator and/or the return line may freeze unless prevented by appropriate freeze-prevention measures, such as a heater. On the other hand, the additional water in the reservoir is not typically required during cold weather conditions and may be allowed to freeze. The additional water becomes thawed during normal operating conditions and is then available if and when needed. During hot weather conditions in which the fuel cell may operate out-of-balance, the additional water from the reservoir is supplied to the fuel cell, ensuring that the fuel cell has sufficient water to operate. The additional water from the reservoir may be selectively connected or disconnected, either directly or indirectly, with the return line to control the supply of water from that source.

These and other features of the present disclosure can be best understood from the following specification and drawings, the following of which is a brief description.

### BRIEF DESCRIPTION OF THE DRAWINGS

FIG. 1 is a schematic view of a fuel cell condensing cooling system having a reservoir.

FIG. 2 is a schematic view of another fuel cell condensing cooling system having a reservoir.

### DETAILED DESCRIPTION OF THE PREFERRED EMBODIMENT

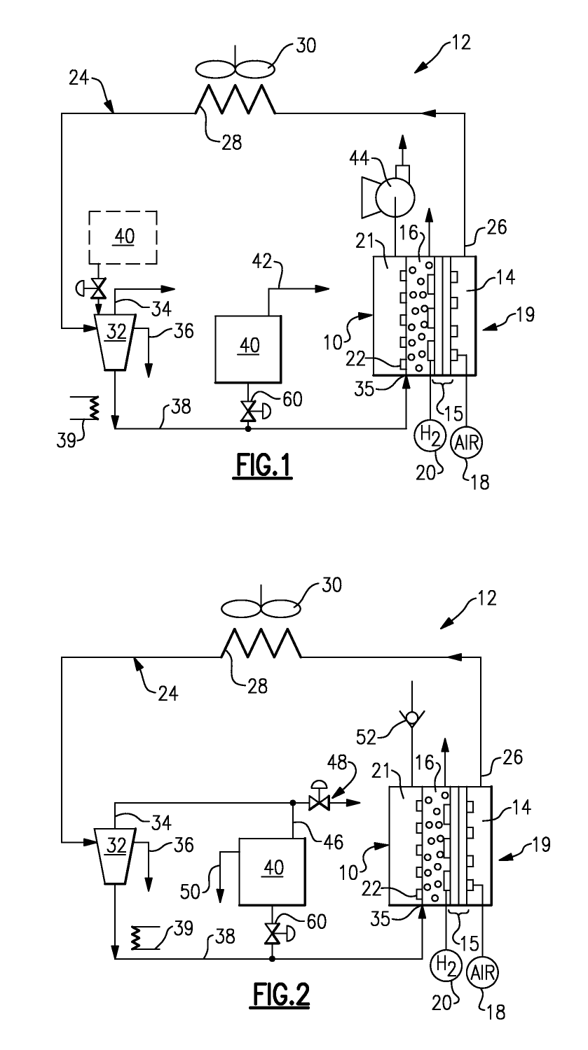

A fuel cell system 12 with a condensing cooling loop 24 is schematically shown in FIG. 1. The system 12 includes a fuel cell 10 having a cathode 14 that receives air from an air source 18 using a compressor, for example. A proton exchange membrane, for example, is arranged as a membrane electrode assembly 15 between the cathode 14 and an anode 16 to form a cell within a stack 19 that produces electricity, as is known in the art. For clarity, only one cell is shown. The anode 16 receives hydrogen from a fuel source 20.

The fuel cell 10 includes coolant water and product water, which is produced as part of the electrochemical reactions within the fuel cell. Porous water transport plates 21 (only one shown) are arranged within the stack 19 to manage and move the water in a desired manner, as is known. The water transport plate 21 includes a water flow field 22, and separates the cathode 14 from the anode 16 of the next-adjacent fuel cell (not shown) while humidifying the reactant streams.

The fuel cell system 12 employs a condensing cooling loop 24 as part of the fuel cell's water management system. Some water exits the fuel cell 10 by first evaporating through the water transport plate 21 into the anode reactant stream, humidifying the membrane. Then, water produced by the electrochemical reaction, as well as any water transported through the membrane by proton drag, are evaporated into the air stream provided by the cathode's air flow field, thereby serving a heat removal function. Moist air exits the fuel cell 10 through an air outlet 26 and circulates to a condenser 28 that condenses the moist air with the assistance of a fan 30, as is known in the art.

Alternatively, a liquid heat exchanger may serve as the condenser. A two phase mixture of coolant water and air leaves the condenser 28 and circulates to a separator 32, where gases are separated from liquid water and the condensed water collects. Any gas ingested by the evaporative cooling loop 24 is expelled through a vent 34. The condensed water flows from the separator 32 to a coolant inlet 35 into the fuel cell 10.

In the example shown in FIG. 1, the water flow field 22 utilizes a vacuum pump 44 to maintain a differential pressure across the water flow field 22 that ensures the water within the evaporative cooling loop 24 returns to the water flow field 22 through the coolant inlet 35. This pump also keeps pressure of coolant water below fuel and air pressure, which prevents water from accumulating in a cell. The separator 32 includes an overflow 36 that expels water if the separator becomes too full.

The separator 32 is fluidly connected to the water flow field 22 through a return line 38. The separator 32 provides water to the water flow field 22 during in-balance, normal operating conditions. The return line 38 may become frozen during cold weather conditions, which would prevent the return of water to the water flow field 22. However, less water is typically needed during cold weather conditions to maintain in-balance operation of the fuel cell, so a frozen return line 38 is not likely to cause the fuel cell 10 to operate out-of-balance. Further, or alternatively, the water volume in the return line is relatively small and is thus easy to thaw, or maintain liquid, as by one or more small heaters 39.

A reservoir 40 contains water and is in communication, directly or indirectly, with the return line 38. The reservoir 40 provides additional water to the water flow field 22 in the event of an out-of-balance condition that may occur during hot weather and, importantly, is connected directly or indirectly to return line 38 in a manner to prevent interference with liquid flow in that return line in the event the reservoir freezes. This may be accomplished by connecting downstream of separator 32, as shown in solid line in FIGS. 1 and 2, or upstream as depicted in dashed line in FIG. 1. The reservoir 40 includes a vent 42. Instead of increasing the volume of water within the stack 19, the additional water is provided in a separate reservoir 40 that may become fluidly separated from the water flow field 22 during freezing conditions. Although the separator 32 and return line 38 are typically drained to avoid problems from freezing, nevertheless their collective liquid volumes are sufficiently small that any water freezing in them is readily thawed by heater 39. On the other hand, because the volume of reservoir 40 is relatively large and may become frozen, it is important that it not be arranged in series in the flow path from condenser 28 through return line 38 and to the water flow field 22 in the stack 19.

While the reservoir 40 is shown physically remote from the stack 19, it may also be located within a common housing of the stack 19. Importantly however, the reservoir 40 is not included in series in the coolant loop 24 as part of the supply to the water flow field 22 so that, when frozen, it does not need to be thawed to obtain in-balance operation of the fuel cell during cold weather conditions. However, it is contemplated that the additional water provided by the reservoir 40 would be used in the coolant loop 24 by the water flow field 22 during hot weather conditions to maintain the fuel cell in-balance. This is accomplished by selectively connecting the reservoir 40 to the coolant loop 24, as by a control valve 60. Notably, the reservoir is connected in a parallel manner to the coolant loop 24, as by being connected fluidly in parallel with the condenser 28 and/or separator 32. The solid line representation of reservoir 40 depicts it being connected to the return line 38 downstream of the separator 32, whereas the dashed line representation depicts that connection being through the separator 32, but in parallel with the condenser 28 and the loop 24 as a whole.

Another arrangement shown in FIG. 2 can be used to circulate the water from the cooling loop 24 back to the water flow field 22 through the return line 38. A pressure control valve 48 is shown in communication with vents 34 and 46 respectively associated with the separator 32 and reservoir 40 for regulating the pressure of the water in the coolant system. The reservoir 40 is shown with an overflow 50 in this example. A check valve 52 is arranged in communication with the water flow field 22. Pressure above atmospheric pressure created by the air flow field of the cathode 14 creates the differential pressure across the water flow field 22 to return water from the evaporative cooling loop 24 to the water flow field 22.

Although a preferred embodiment has been disclosed, a worker of ordinary skill in this art would recognize that certain modifications would come within the scope of this disclosure. For that reason, the following claims should be studied to determine the true scope and content of this disclosure.

1. A fuel cell system comprising:
a fuel cell having a cathode and an anode, and a water flow field in fluid communication with the cathode such that moist air is produced; and
a cooling system including a condenser arranged to receive the moist air and produce condensed water, a return line fluidly connecting the condenser and the water flow field, and a reservoir in fluid communication with the return line at least part of the time for selectively providing additional water to the water flow field in an out-of-balance hot fuel cell conditions, the reservoir being in parallel fluid relation with the condenser in the cooling system.

2. The fuel cell system according to claim 1, wherein the cooling system further includes a separator arranged to receive the condensed water, and the return line fluidly connects the separator and the water flow field.

3. The fuel cell system according to claim 2, wherein the reservoir is arranged downstream from the separator.

4. The fuel cell system according to claim 2, wherein the reservoir is arranged upstream of the separator.

5. The fuel cell system according to claim 1, wherein a fan is associated with the condenser to create a desired temperature differential across the condenser.

6. The fuel cell system according to claim 1, wherein a porous water transport plate is arranged between the cathode and the water flow field, the water transport plate hydrating the cathode to provide moist air within an air flow field of the cathode.

7. The fuel cell system according to claim 1, wherein the separator and reservoir include a vent, and a pump draws a vacuum on the water flow field to create a differential pressure across the water flow field for returning the condensed water to the water flow field through the return line.

8. The fuel cell system according to claim 1, wherein the separator and reservoir include a check valve, and an air source provides air to the cathode, the air source creating a differential pressure across the water flow field to return condensed water to the water flow field through the return line.

9. The fuel cell system according to claim 1, wherein the reservoir is in fluid connection with the return line during an out-of-balance hot fuel cell condition.

10. A method of evaporatively cooling a fuel cell comprising the steps of:
providing a cooling loop receiving moist air from a cathode to produce liquid water;
returning the liquid water to a water flow field associated with the cathode;
selectively supplying additional water to the water flow field under predetermined operating conditions: and
wherein the additional water becomes frozen during a freezing condition, and including the step of operating the fuel cell in-balance without the additional water in the frozen condition.

11. The method according to claim 10, wherein the predetermined operating condition corresponds to an out-of-balance hot fuel cell condition.

12. The method according to claim 11, wherein the out-of-balance hot fuel cell condition corresponds to an insufficient supply of liquid water within the fuel cell.

13. (canceled)

14. The method according to claim 10, comprising the step of applying a vacuum to the water flow field to return the liquid water to the water flow field.

15. The method according to claim 10, comprising the step of applying a pressure above atmospheric pressure to the water flow field to return the liquid water to the water flow field.

16. The fuel cell according to claim 9, wherein the reservoir is frozen during a cold weather condition thereby preventing frozen water within the reservoir from reading the water flow field.
